(19) United States
(12) Patent Application Publication
(10) Pub. No.: US 2005/0199267 A1
(43) Pub. Date: Sep. 15, 2005

(54) Washing system using recycled cleaning liquid

(76) Inventor: Kenton T. Oakes, El Cajon, CA (US)

Correspondence Address: William J. Kolegraff, 3119 Turnberry Way, Jamul, CA, 91935, US

(21) Appl. No.: 10/800,600

(22) Filed: Mar. 15, 2004

(51) Int. Cl. B08B 3/02

(52) U.S. Cl. 134/10; 134/40; 134/111; 134/172; 134/184; 134/113

(57) ABSTRACT

A washing system uses recycled cleaning liquid, such as water, to clean parts and tools that are positioned in a washing basin or sink. In one example, the washing system uses a washer fixture to spray water over a pottery tool that is soiled with a clay or other contaminant. Water, as well as pieces and chunks of the clay and contaminant discharge from the sink through a drain line and into a trap vessel, where heavier pieces of the clay or other contaminant settle. The water and smaller particles flow into a filter vessel, where further contaminants and particles are removed from the water. The filtered water is pumped back to the sprayer, where the water is re-used. The tool is cleaned using recycled cleaning liquid, and without connection to a sewer or drain line.

### BACKGROUND

The field of the present invention is washing systems. More particularly, the present invention relates to a portable and self-contained washing system.

Artisans and craftspeople often have tools or parts that need cleaning. For example, a potter uses several tools to form clay into useful or decorative objects. These tools may accumulate a significant amount of clay during use, and the clay must be removed prior to storage or at the end of a work period. In cleaning these tools, the craftsperson may simply take the tools to a sink and wash them. Unfortunately, clay is a relatively dense material, and readily accumulates in pipes, traps, and plumbing fixtures. This accumulation leads to clogs, which can back up and cause flooding or other water damage. Further, unclogging drains is time consuming, may damage pipes, and may require the expense of a professional plumber. In some cases, the plumber may even have to remove and replace sewer or drain lines, a very costly and disruptive process. To minimize clogging, cleaning is generally done slowly and with a large quantity of water to allow the clay to dissolve or be swept away. This is very wasteful of our potable water supply.

Because clay so readily causes clogged drains, many craftspeople, potters, and pottery instructors find alternative ways to clean tools and parts that avoids or reduces the use of a sewer connection. In one example, they use paper towels to remove as much of the clay as possible. However, using a paper towel to clean a tool is time consuming, and is seldom able to properly clean a tool. The craftsman or potter may still need to clean the tool in the sink, even after toweling. Although less clay will enter the drain and sewer, clogs are still likely. In another example, craftspeople or potters will clean tools and parts outside, for example. Typically, they will collect up all their tools in a bucket, find a spot outside, and use a garden-style hose to clean the tools, where chunks and pieces of clay can fall onto the grass, plants, or walkways. Of course, it is time-consuming and inconvenient to take all the tools outside, and it is likely that the craftsman or potter gets wet and dirty from the spray and splash of the garden hose. Further, cleaning the tools outside may leave piles of clay, which can be unsightly, slippery, and may be tracked indoors, creating another clean-up mess, and the clay or other contaminants may also damage or kill plants.

Artisan studios, such as a pottery studio or instructional studio, are often built in garage areas, spare rooms, or other areas without convenient sewer or water connections. Even commercial studios can be built in areas without proper water and sewer connections, and if sewer and water is available, it may not be convenient to where clean-up is needed. Adding proper sewer and water connections can be expensive, and still may not provide for clean-up where desirable.

Sometimes clay or other art material, such as paint supplies, paint, glazes, stains, slips, or other soluble material, is on the tools and parts that artisans and craftspeople desire to capture and reuse. For example, some special clays may be difficult to replace, or some glazes and coatings may be quite expensive. In the cleaning process, these materials may be lost down the sewer connection. Others have attempted to enable the recycling of such material. For example, U.S. Pat. No. 6,049,922, entitled “Solid-Sediment Retaining Plumbing Trap” discloses a plumbing trap that connects between a sink and the sewer system. The trap collects sediments into a bottle, and when the bottle fills, the bottle is replaced. The collected material may then be reused. However, the disclosed trap connects directly to the sewer system and relies on running water, and therefore suffers from the cleaning limitations discussed above.

### SUMMARY

Briefly, the present invention provides a washing system that has a washer fixture directing a cleaning liquid into a washing basin. The washing basin holds a contaminated part. The cleaning liquid, as well as the contaminant, flows through a drain line into a trap vessel, where heavier pieces of the contaminant settle. The cleaning liquid and particles of the contaminant flow into a filter vessel, where contaminant is further removed from the cleaning liquid. The cleaning liquid is pumped through a wash line to the washer fixture. The part is cleaned using recycled cleaning liquid, and without connection to a sewer or drain line.

In one example of the washing system, the washing system is mounted on a cart housing and uses buckets for the vessels. The cart enables the washing system to be conveniently moved to where clean-up is needed. The filter bucket has a float system that allows the pump to draw cleaning liquid from near the top of the liquid. In this way, the pump draws cleaning liquid that is likely to be more settled than liquid near the bottom of the filter bucket. Also, the filter bucket includes a filter bag that collects particles of contaminant. The filter bucket may be easily removed from the cleaning system, and the pump reconnected to draw cleaning liquid directly from the trap bucket. In this configuration, the washing system may be used to clean the filter bag.

In another example of the washing system, the washing system is more permanently installed in a studio or work area. The washing system may be configured to connect with a water supply as fresh water is needed, and may connect to a sewer line when the system needs to be flushed. If water or sewer is not conveniently available, then buckets may used to dispose of dirty liquid, and a temporary hose may be used to add fresh water.

Advantageously, the disclosed washing system enables efficient washing without connection to a liquid line or to a drain line. In this way, the washing system enables clean-up in locations where there is no or limited access to water or sewer connections. And when configured as a portable system, the washing system may be moved where clean-up is needed. The washing system uses recycled water and enables the capture and reuse of materials, so it is therefore environmentally friendly. Clean-up may be performed where it is needed, without clogged drains, without damage to pipes, and without waste.

### BRIEF DESCRIPTION OF THE DRAWINGS

FIG. 1 is an isometric front illustration of a portable washing system in accordance with the present invention;

FIG. 2 is an isometric rear illustration the portable washing system shown in FIG. 1;

FIG. 3 is a block diagram of a washing system in accordance with the present invention;

FIG. 4 is a top view of a diagram of a filter and float mechanism useful in a washing system in accordance with the present invention;

FIG. 5 is flowchart of a method of cleaning in accordance with the present invention;

FIG. 6 is a block diagram of a washing system in accordance with the present invention;

FIG. 7 is flowchart of a method of cleaning in accordance with the present invention; and

FIG. 8 is a block diagram of a washing system in accordance with the present invention.

### DETAILED DESCRIPTION

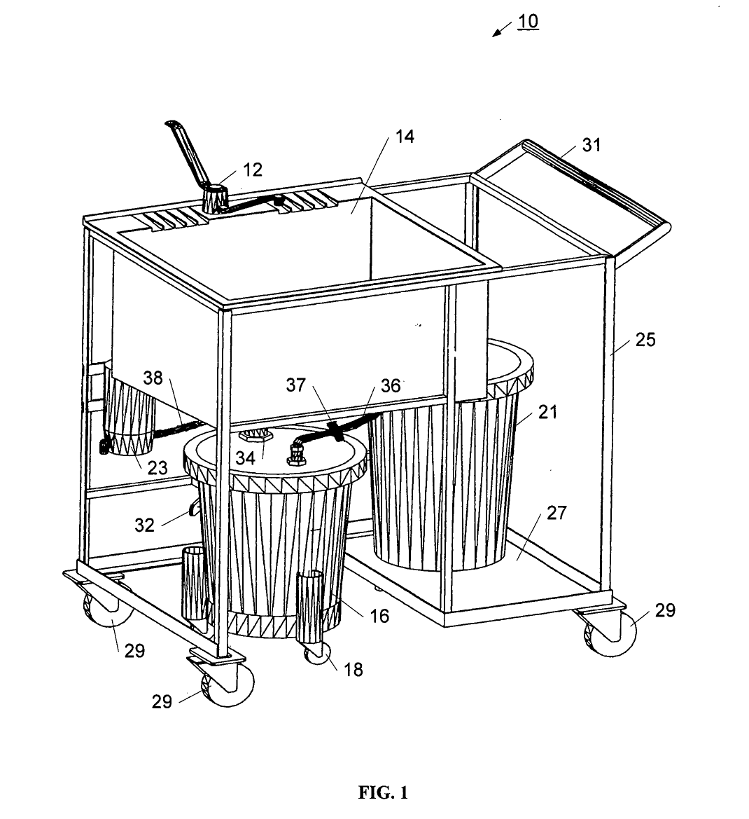

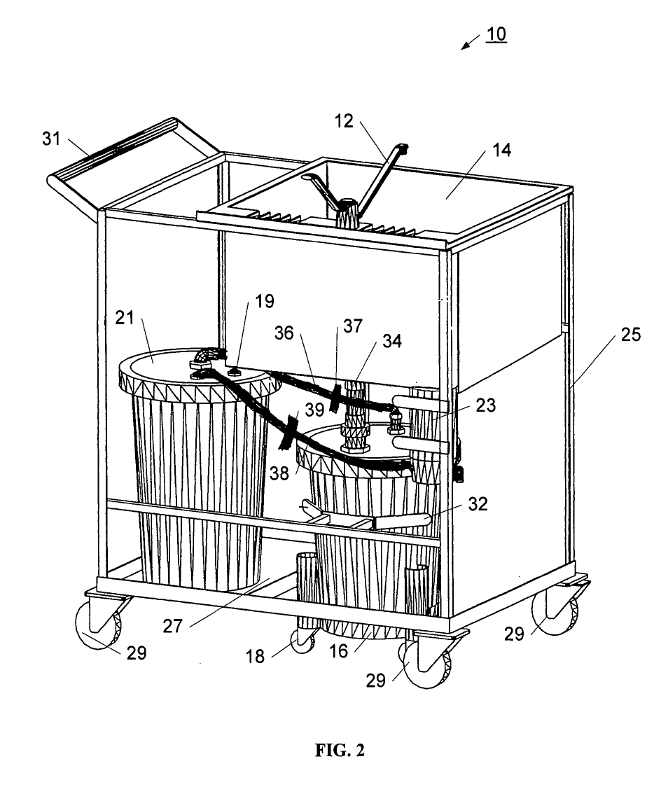

Referring now to FIG. 1 and FIG. 2, a washing system 10 is shown. Washing system 10 is illustrated as a portable and self contained cleaning system. In particular, washing system 10 is particularly suited for clean up in an artisan or craftsperson studio. For example, washing system 10 may be used for cleaning tools, parts, and accessories used in making clay or ceramic pottery. Although washing system 10 is illustrated for a particular studio application, it will be appreciated that cleaning system 10 may be readily modified for other cleaning applications.

Washing system 10 has a sink 14 for receiving dirty parts, tools, or other items to be cleaned. A washer fixture 12 is positioned to direct a stream of cleaning liquid onto the parts. For example, the washer fixture 12 may be a faucet, spray gun, or other fixture assembly for directing a stream of liquid onto the parts. In one example of washing system 10, the cleaning liquid is water. It will be appreciated that additives may be added to the water to improve cleansing ability or to increase the useful life of the water. For example, a soap may be added for increasing cleansing ability, or a bleach may be added for control of bacteria and algae growth. The cleaning liquid is directed to the parts, likely with force, where the cleaning liquid may knock off chunks and pieces of contaminant, rinse off particulates, and dissolve some of the contaminant. For example, if a tool having a large quantity of clay is placed in sink 14, the water stream would likely knock off large chunks of clay, wash some of the clay particulate matter away, and may dissolve some of the clay. The water, particulate matter, and chunks discharge through drain line 34 into a trap bucket 16. The sink 14 may have one or more screens at the top of the drain line to restrict overly large chunks from falling into the trap bucket 16. In this way, an operator may dispose of particularly large chunks in an alternative manner, or may break the chunks into pieces small enough to pass through the screen mesh.

The trap bucket 16 is a trap vessel for collecting the large chunks of contaminant and allowing larger particulate matter to settle. Because the trap bucket 16 collects large chunks of contaminant and heavier matter, the trap bucket 16 may benefit from more frequent emptying. Accordingly, trap bucket 16 has wheels 18 for allowing the trap bucket 16 to be conveniently rolled to a disposal area. When the trap bucket 16 fills with water, the water passes through feed line 36 into a filter bucket 21. In one example, the water flows from the trap bucket 16 to the filter bucket 21 under gravity flow. It will be appreciated that a pump or a other arrangement may be used. A bleed line 119 may extend from the filter bucket 21 to enable water pressure to equalize in the system. The bleed line may also include a bleed valve or pressure valve to allow air to be expelled, but retain the cleaning liquid. In one example, the bleed line 119 extends from the filter bucket to the sink 14. The outlet from the bleed line is positioned above the expected level of liquid in the sink to avoid water flowing through the bleed line into the filter bucket. It will be appreciated that other mechanisms may be used to equalized pressure and improve liquid flow in the washing system.

The filter bucket 21 contains a filter bag or other filtering mechanism to further remove particulate matter from the water cleaning liquid and also may allow further settling and collection of finer matter. Since much less contaminant will be retained in filter bucket 21 as compared to the trap bucket 16, filter bucket 21 is likely to need less frequent cleaning, and therefore rests upon platform 27.

A pump 23 draws water from the filter bucket 21 through a draw line 38. The pump 23 then pumps the water to the washer fixture 12 and into the sink 14, if the fixture's valve is open. The washing system 10 is arranged as a fully independent and portable unit. Washing system 10 contains a cart housing 25 for holding and arranging the components of the cleaning system. For example, the cart housing 25 contains a platform 27 for supporting the filter bucket, and a retention mechanism 32 for retaining the trap bucket 16. In one example, the retaining mechanism 32 includes a strap for holding the filter bucket to the cart housing 25, or may use a hook and loop material for retaining the filter bucket 16 to the retaining mechanism 32. In this way, the trap bucket 16 is retained to the washing system 10 even though the trap bucket 16 has in independent wheel system. Preferably, the cart housing 25 also has wheels 29 allowing the cart to be rolled easily. Further, cart 25 has a handle 31 to more easily direct the cart. It will be appreciated that the washing system may be arranged in other types of housings, containers, and transports consistent with this disclosure. For example, a modified washing system could be mounted on a motorized vehicle for providing a washing system to a remote locations. In another example, the system could be configured as a more permanent installation. In this case, the washing system would only need to connect to sewer and water as needed, and otherwise could operate using recycled water.

Washing system 10 my be arranged with a quick connect coupling 37 on the feed line 36, and a similar quick connect coupling 39 on the draw line 38. In this way, the filter bucket 21 may be quickly bypassed and detached from the feed line and the draw line for cleaning. The quick connects 37 and 39 are arranged so that when disconnected, one part of quick connect 37 mates with a corresponding part of quick connect 39, thereby coupling the feed line 36 directly to the draw line 38. In this way, the pump may draw cleaning water from the trap bucket 16 for delivery into sink 14 through washer fixture 12. Such an arrangement is particularly useful for cleaning or maintenance of washing system 10. For example, the filter bucket 21 may be bypassed or disconnected from the system, the filter removed from the filter bucket, and the filter placed in sink 14. The drain line 34 may be quick connected to the draw line 38, and water drawn from the trap bucket for cleaning the filter. The particulate in the filter bag may then settle into the trap bucket 16. The trap bucket may then be disconnected from the washing system 10 and rolled away for easy disposal or reuse of the contaminant.

Advantageously, washing system 10 is a self contained and portable washing system. In this regard, the washing system 10 enables the effective and efficient cleaning of contaminated parts without the need for connection to a fresh water supply or connection to a sewer line. Further, since contaminant material is retained in a set of buckets, large quantities of contaminant are not introduced into the sewer system, thereby avoiding clogging of drains. Also, the contaminant may be recycled. For example, trap bucket 16 or filter bucket 21 may retain quantities of clay, glaze, or other substance that may be reused in the studio. For contaminant that will be not recycled, that contaminant may be removed to other disposal containers and disposed of without flushing the contaminant into the public sewer systems. Washing system 10 also may be advantageously rolled to where a cleaning process is to be performed. In this way, an operator may roll the cart to one area of a studio for cleaning, and then move the cart to another area for cleaning at a different time. This avoids having to transport dirty or contaminated parts from one area of the studio to another. Washing system 10 also enables the highly efficient recycling of water or other cleaning liquid. In this way, less water is used, conserving resources, while still enabling the efficient cleaning of parts or tools. Although fresh water or other cleaning solution may need to be added to washing system 10 due to evaporation or other losses during use, it is anticipated that the water or other cleaning liquid may be substantially recycled prior to disposal. For example, a typical home studio may be able to use washing system 10 for several months before full disposal and change of the liquid, while a commercial studio may be able to go several days or weeks before a full change out of liquid. A tablespoon or two of bleach should be added occasionally to avoid algae or bacterial growth. It will be understood that the specific amount of bleach will be dependent on environmental conditions, types of contaminants, and other local factors.

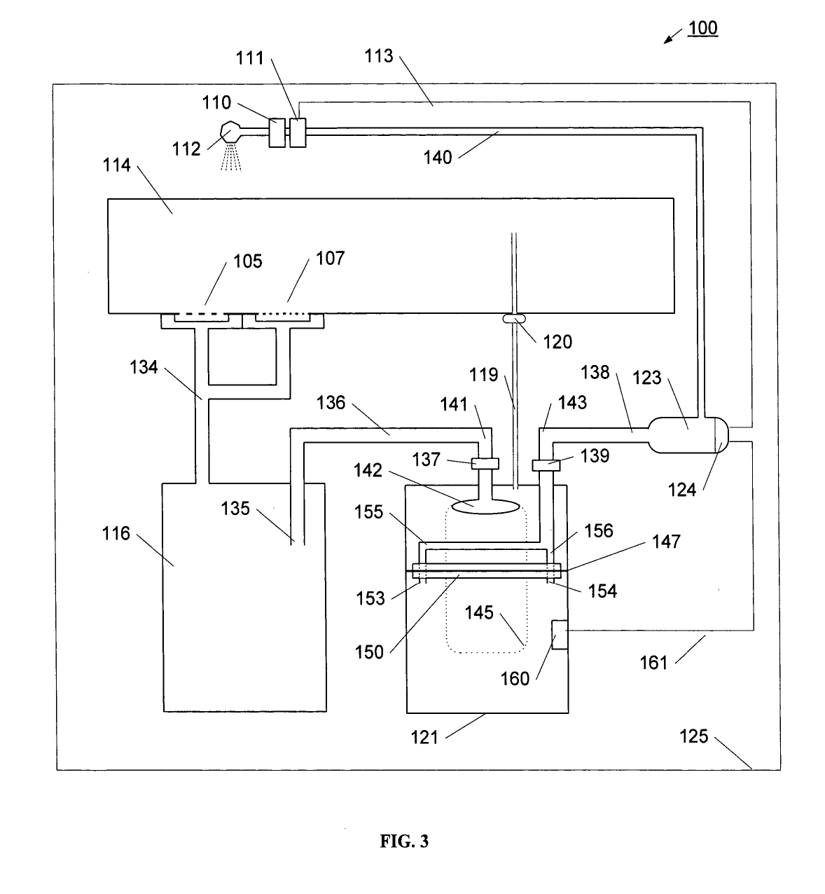

Referring now to FIG. 3, another example of a washing system is illustrated. Washing system 100 includes a basin 114 in the form of a sink. Sink 114 is useful for receiving a cleaning liquid, such as water, from washer 112. Washer 112 may be for example, a faucet outlet or spray gun. Sink 114 may include one or more screen mesh systems. For example, sink 114 includes a coarse mesh 105 and a fine mesh 107 to assist an operator in cleaning a part or tool. If the operator desires to immediately recycle chunks coming from a particular tool, the operator may place the tool over fine screen 107. In this way, liquid, particulate matter, and small pieces would flow into drain line 134, but large pieces and chunks would be retained on screen 107. At other times, the operator may not be concerned with immediate recycling or capture of contaminant, and may place the part over coarse mesh 105. Because of the spacing of the mesh, larger chunks will fall through coarse mesh 105, through drain line 134, and directly into trap vessel 116. Trap vessel 116 may be in the form of a bucket, pail, tank, or other liquid receptacle, and is used to receive chunks, pieces, particulate matter, and cleaning liquid flowing from sink 114. Heavier contaminant collects at the bottom of trap vessel 116, which may be periodically removed by an operator.

The cleaning liquid flows by gravity from feed inlet 135 into feed line 136 and into filter vessel 121. It will be understood that a pump may alternatively be used to draw or push the liquid between vessels. A bleed line 119 may be extended from the filter bucket 121 to a discharge point above the liquid level in the sink 114. Positioned in this way, it is less likely that liquid will be discharged from the bleed line 119, or that liquid could flow through the bleed line 119 into the filter bucket 121. The bleed line 119 may also include a bleed valve 120 or pressure relief valve for equalizing pressure in the system. When the pump 123 is drawing liquid from the filter bucket 121, the filter bucket 121 operates at a lowered pressure, so the bleed valve 120 acts to seal the bleed line 119. However, when the pump 123 stops, air may flow from the filter bucket 121 and be discharged. As some moisture may also escape, the bleed line 119 may be discharged into the sink 114. If the pump 123 is deactivated while water remains in the sink 114, the bleed line 119 may facilitate the release of sufficient air to allow the remaining water to drain into the trap bucket 116.

Filter vessel 121 may also be a bucket, pail, tank, or other liquid receptacle. It may be the same size as the trap vessel, or may have a different size according to filter requirements. It will also be understood that more than one filter vessel may be used, with different filtering process performed in each successive vessel. For example, a first filter vessel may provide for silt settling, while other vessel or vessels provide for filtering with finer filters. In another example, more than one filter can be provided in the filter vessel. However, for many applications, a single trap vessel and a single filter vessel is sufficient.

The feed line 136 connects to a manifold positioned inside the filter vessel 121. The manifold 142 acts to evenly distribute the water or cleaning liquid into the filter vessel 121 to reduce disturbance to the liquid. In this way, settling is facilitated. The manifold 142 is also sized to receive a filter bag 145. In one example, the filter bag 145 is retained onto the manifold 142 by an elastic collar or band. It will be appreciated that the filter bag may also be mechanically attached or frictionally retained to the manifold. As cleaning liquid flows through feed line 136, through manifold 142, and into filter bag 145, particulate matter will be retained inside the filter bag 145. Cleaner water then flows through the bag for further use and recycling.

A pump 123 is used to draw water from the filter vessel through a draw line 138. The draw line 138 couples to inlet line 155 and inlet line 156. Inlet lines 155 and 156 are coupled to inlets 153 and 154, respectively. Inlets 153 and 154 are positioned on float 150. Float 150 is preferably made of a material capable of being buoyed by the cleaning liquid. For example, float 150 may be made of a Styrofoam or other plastic material if the cleaning solution is water. It will be appreciated that other materials may be selected for the float if other cleaning liquids are used. It will also be appreciated that the float may be solid, or may be formed as a sealed hollow. The float 150 and the inlets 153 and 154 are arranged so that when the float is buoyed in the cleaning liquid, the inlets 153 and 154 are positioned in the cleaning liquid. In this way, the pump is able to draw cleaning liquid from the area near the surface of the liquid level 147. The cleaning liquid is drawn through the inlet lines 155 and 156, into draw line 138, and into pump 123.

Float 150 is designed as a floating disc positioned around the filter bag 145. Since the float 150 is buoyed by the cleaning liquid, the position of the float in the filter tank 121 is determined by the liquid level 147. For example, as the liquid level drops, the float will move further down in the filter tank 121 to continue drawing water. Since it is likely that the water near the liquid level 147 is cleaner than the water at the bottom, it is desirable to draw the water from near the top surface of the cleaning liquid. By allowing the inlets 153 and 154 to float with the float 150, additional fresh cleaning liquid needs to be added less often. Even though washing system 100 has such a variable inlet, it will be appreciated that other more static methods may be used, or other methods may be used for variably removing water.

Pump 123 pumps water into wash line 140. Wash line 140 is under pressure due to the action of pump 123. When valve 110 is open, water is directed out of washer 112 and into sink 114. In this way, water or other cleaning liquid is continuously recycled in washing system 100. Advantageously, cleaning system 100 does not use any direct coupling to a fresh water source or to a public sewer system. In some applications, it may be desirable to regularly introduce some fresh water into the system, so an attachment (not shown) may be made to a fresh water system. In a similar manner, in some applications if may be desirable to regularly discharge some filtered water, so an attachment (not shown) may be made to a sewer system or other discharge system.

Washing system 100 may also contain a housing 125. Housing 125 may be in the form of a cart or other portable structure to enable the washing system 100 to be moved easily from one location to another. In this construction, the cleaning system 100 is a portable, and self contained washing system. Such portability is particularly desirable where cleaning needs to be performed at a location remote from water and sewer connections.

In another example, housing 125 may be a counter, cabinet, or other more permanent structure for housing the washing system. Even when more permanently installed, the washing system still cleans using recycled water. The washing system may be installed more permanently, even where water or sewer connections are not immediately available. In such an installation, buckets or hoses would be used when the washing system needed flushing or new water. In other installations, water or sewer may be convenient, and the washing system may provide for occasional coupling to the water source or sewer. For example, valve 110 could connect to a water source and allow an operator to add fresh water only as needed. In another example, the filter bucket could have a drain valve and drain to the sewer. An operator could open the drain valve when the washing system is flushed to discharge filtered water into the sewer, and thereby reduce the weight of the buckets.

Pump 123 may optionally contain pump control circuitry 124. Pump control circuitry 124 may be coupled to a sensor 111 using pump control line 113. Sensor 111 may be positioned to detect when valve 110 has been turned on to allow water to flow into the sink. For example, sensor 111 may mechanically sense the position of valve 110. Alternatively, sensor 111 may automatically detect the pressure in wash line 140. In this way, when the valve 110 is opened and the pressure drops in line 140, the sensor 111 could be activated. When sensor 111 is activated, it instructs control circuitry 124 to activate pump 123. In this way, the sensor detects when the valve 110 is open, and the pump automatically activates to drive water through wash line 140. Sensor 111 may also act to sense when the valve 110 is closed. For example, switch 111 may physically detect when the switch is closed, or may detect a rise in pressure in wash line 140. Responsive to either the switch position or the pressure, the sensor 111 could generate a signal for control circuitry 124 to deactivate the pump.

Alternatively, sensor 111 may require manual intervention of an operator to deactivate the pump. For example, sensor 111 may be configured as a manual switch that an operator uses to turn the pump on or off. When using such a switch, it may not be necessary to use a valve in the wash line, as the pump acts to start and stop the flow of cleaning liquid. Pump control circuitry 124 may also optionally be connected to a sensor 160. Sensor 160 is positioned inside of filter bucket 121 for detecting when the level of water becomes too low. Once the water level falls below a predefined level, the cleaning solution may be too dirty for proper cleaning, and additional water or cleaning liquid should be added. In this regard, sensor 160 detects when the water level is too low, and using signal line 161, may not allow pump 123 to be activated, even after valve 110 is open.

In another example, sensor 160 may connect to an indicator for indicating to an operator, for example through a lighted display, that additional fresh cleaning liquid is needed. In another example, sensor 160 is used to sense the amount of particulate or dissolved solids in the cleaning liquid, and deactivates the system or warns the operator when the cleaning liquid becomes too dirty. In one example, sensor 160 is an optical sensor directing a light beam through the cleaning liquid and to an optical sensor. When the light beam is sufficiently restricted by the cleaning liquid, the sensor detects the cleaning is too dirty and notifies the operator or causes the pump to remain deactivated. In another example, the sensor 160 may be used to detect the amount of particulate or dissolved matter in the cleaning liquid, and provide a graphical or other display to the operator showing a relative level of contaminant in the water. In this way, an operator may be able to make a more informed decision about what type of parts to clean, and when to cycle the water.

The feed line 136 has a quick connect 137 for coupling feed line portion 141 to the filter bucket 121. In a similar manner, draw line 138 has quick connect 139 for coupling draw line portion 143 to the filter bucket 121. By decoupling the quick connects 137 and 139, the filter bucket may be easily and conveniently removed from washing system 100. It will also be appreciated that other fluid lines may include quick disconnects for easily removing other aspects of the washing system. For example, quick disconnects may be provided on the drain line and the feed line for easier removal of the trap bucket 116. Also, quick disconnects may be provided on the wash line 140 for facilitating adding or removing optional washing equipment. Since the structure and use of quick connects is well understood, the quick connects will not be discussed here in detail.

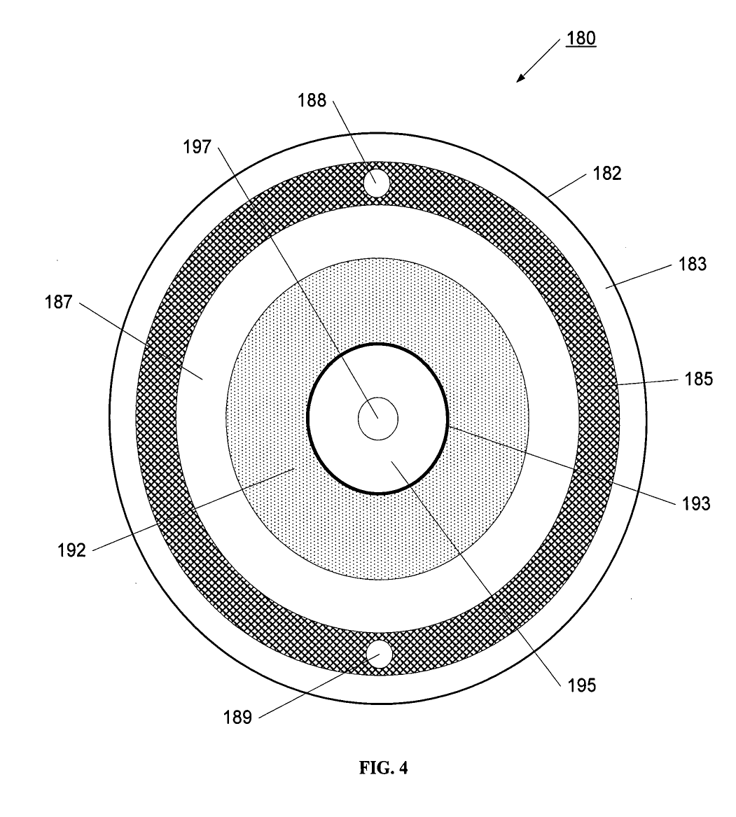

Referring now to FIG. 4, additional detail is provided for a float and filter system 180 useful in a washing system. Float and filter system 180 is similar to the float and filter described with reference to FIG. 3. Float and filter 180 is intended to be used in a filter bucket. The filter bucket has a filter bucket wall 182 for retaining a cleaning liquid and the float and filter assembly 180. A float 185 is positioned in the filter bucket. Preferably, the float 185 is constructed as a disc and is constructed from a material selected to be buoyed by the cleaning liquid. For example, float 185 may be made from a Styrofoam, plastic, or other material which floats in the cleaning liquid and is not harmed by the contaminants likely to be contained in the liquid. In another example, float 185 may be a sealed hollow member.

Cleaning liquid, such as water, is introduced into the filter bucket through feed line 197. The cleaning liquid is likely to contain particulate matter and other small solids. Feed line 197 couples to a manifold 195 for distributing the cleaning liquid into the filter bucket. The manifold 195 acts to more evenly distribute the liquid to cause less disturbance, thereby facilitating particulate settling from the liquid. A filter bag 192 is fitted onto the manifold 195. In one example, an elastic band 193 on the filter bag 192 acts to frictionally retain the filter bag 192 onto the manifold 195. It will be appreciated that different arrangements may to used to attach a filter bag or filtering structure to the inlet system. In one example, the filter bag is a 15 micron mesh filter for retaining particulate matter larger than 15 microns. It will be appreciated that different types of filters and sizes of filters may be used according to applications specific needs. Further, it will be appreciated that multiple filtering systems may be used. For example, a first filter may be set at a coarser mesh, while a second filter may be chosen at a finer mesh. Also, it will be understood that the multiple filter system may be included inside one filter bucket, or may be present in more than one bucket.

The filter 192 and the float 185 are sized such that a space 187 is present between the filter 192 and the float 185. Also, the float 185 is sized so that a space 183 exists between the float 185 and the wall 182 of the filter bucket. In this way, the float 185 may raise and lower responsive to a change in the liquid level of the cleaning fluid. Inlet connections 188 and 189 are positioned on the float for positioning inlets into the cleaning liquid. Since the float 185 is buoyed by the cleaning liquid, the inlets are positioned near the upper level of the cleaning liquid. In this way, cleaner cleaning liquid is drawn from the filter bucket. Although float 185 is shown with 2 inlets, it will be appreciated that more or less inlets may be used. It will also be understood that the specific arrangement between the feed line 197, the manifold 195, the filer 192, and the float 185 may be alternatively arranged. For example, the filter bag may be positioned on one side of the bucket while the float system may be positioned on another side. It will also be appreciated that additional structure may be included in the bucket. For example, a baffle or sectioning material may be used to separate the inlet and filter area from the float and water drawing area.

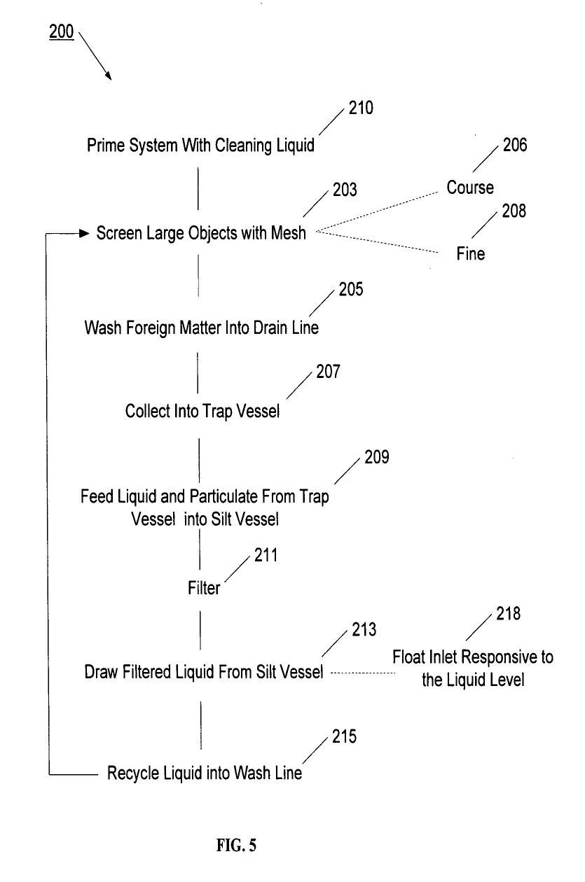

Referring now to FIG. 5, a method of cleaning 200 is illustrated. Method of cleaning 200 generally uses a cleaning system such as washing system 100. Method 200 begins with priming the system with fresh cleaning liquid as shown in block 210. To prime the system, fresh cleaning liquid is added to the storage vessels, such as a trap vessel and a filter vessel. It will be appreciated that additional vessels may be used. Once the cleaning system has been primed with the cleaning liquid, the cleaning system preferably may be detached from the fresh cleaning liquid source. For example, if a water line is used to prime the cleaning system, the fresh water line may be detached once the system is primed. Priming or freshening the cleaning liquid may be accomplished, for example, simply by adding fresh water into the sink. Alternatively, the filter or trap buckets may be temporarily disconnected and filled. After priming, the cleaning system may become a portable cleaning system that operates independently from the water source.

In use, parts or tools are placed in a sink, and the sink may have a mesh restricting the passage of objects larger than the mesh as shown in block 203. In some examples, multiple meshes may be provided. For example, a coarse mesh may be provided 206 allowing large pieces to flow directly into a trap bucket, and a fine mesh 208 may be provided when the operator desires to collect large pieces in the sink for immediate removal or reuse. The cleaning liquid is sprayed or otherwise projected onto the tool or part, thereby washing foreign matter or contaminant into a drain line as shown in block 205. Larger chunks, pieces, and large particulate is collected in a trap vessel as shown in block 207. Liquid discharged from the trap vessel is likely to contain particulate matter and flows from the trap vessel into a silt or filter vessel for further processing. Preferably, the silt vessel contains a filter 211 for filtering out particulate matter. Alternatively, the silt vessel may have a sufficiently large volume and physical arrangement to allow substantial settling of the particulate from the cleaning liquid.

The settled or filtered cleaning liquid is then drawn from the silt vessel as shown in block 213. Preferably, the liquid is drawn from the upper level of the liquid, where it is likely the cleaning liquid has less particulate matter. In one example, an inlet is floated near the top surface as shown in block 218. The liquid drawn from the silt vessel is then pumped into a wash line as shown in block 215 where it is used to be sprayed or projected into the sink for washing parts or tools. In this way, the cleaning liquid is recycled. The cleaning method 200 facilitates the removal of chunks, pieces, and large particulate contaminant matter into a trap vessel, filters out or settles smaller particulate in the silt vessel, and recycles sufficiently cleaned cleaning solution for reuse as a cleaning agent.

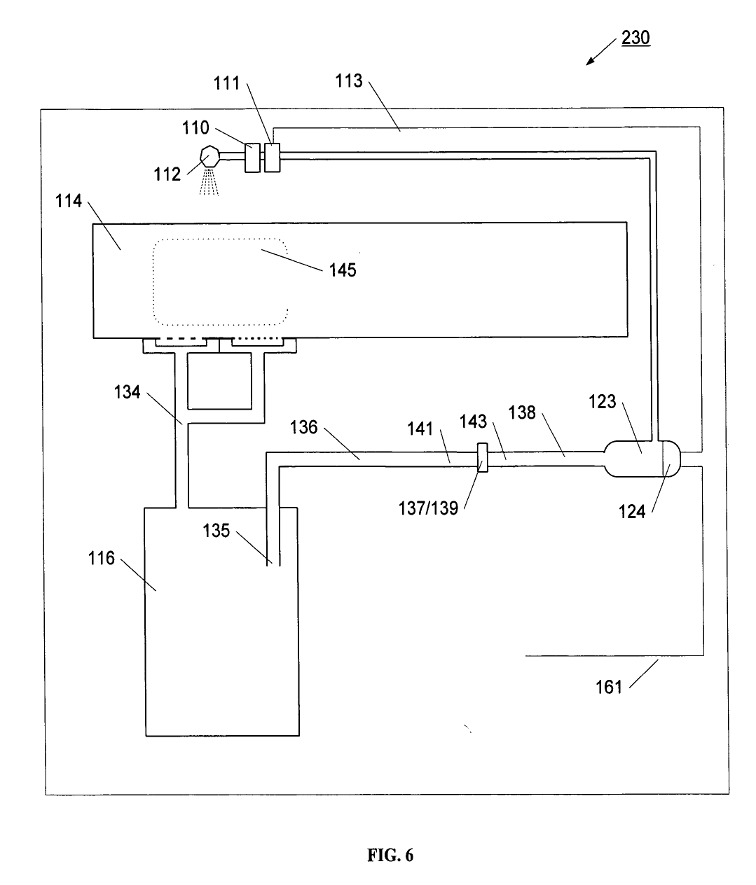

Turning now to FIG. 6, a washing system 230 is illustrated. Cleaning system 230 is like cleaning system 100 described with reference to FIG. 3, except the filter bucket and some connecting structure has been removed. More specifically, the quick connect 137 and quick connect 139 have been decoupled, as well as control line 161 (if present). The filter bucket 121 has been removed from washing system 230 for further cleaning. In one example of cleaning the filter bucket 121, the filter 145, which has been removed from filter bucket 121, is placed in sink 114. The quick connects 137 and 139 have been arranged so that the feed line portion 141 may be connected to draw line portion 143 using mating and compatible parts 137/139. By connecting feed line portion 141 to draw line 143, the pump 123 is able to directly draw cleaning solution from trap vessel 116. In this way, water is drawn from trap vessel 116, is pumped through pump 123, and into washer 112, where the cleaning liquid may be directed onto filter bag 145 for cleaning. Advantageously, washing system 230 enables washing system 100 to be reconfigured to facilitate the efficient cleaning of the filter bucket 121.

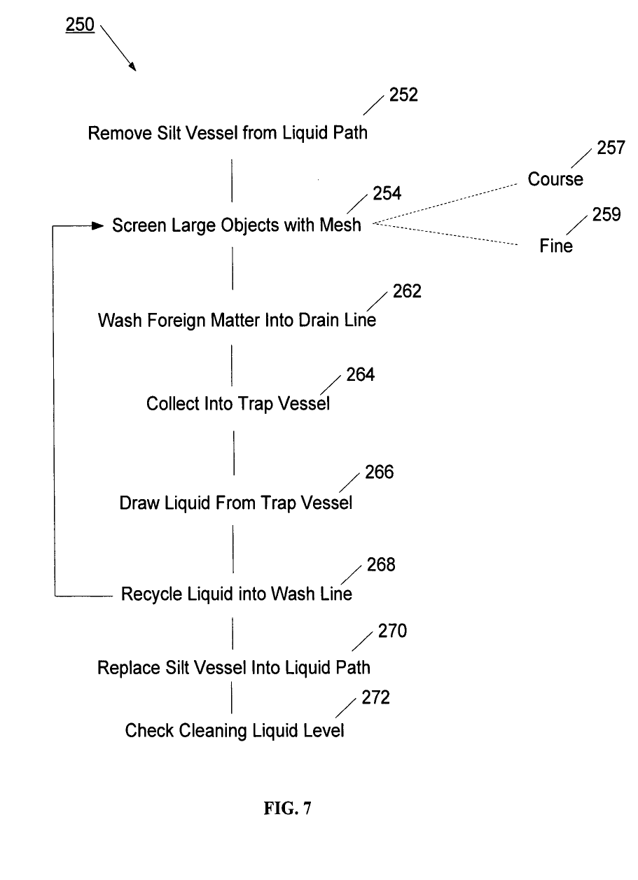

Referring now to FIG. 7, a method of cleaning 250 is described. In method 250, the silt or filter bucket is removed from the liquid path as shown in block 252. The filter is removed from the filter bucket and placed in a sink, which may include a mesh as shown in block 254. In one example, multiple meshes may be used such as a coarse mesh 257 and a fine mesh 259. Water is directed over the filter bag to wash foreign matter into a drain line as shown in block 262. Any large pieces may be immediately trapped in trap vessel 264 or finer particulate may settle in trap vessel 264 after a sufficient settling time. Liquid is drawn directly from the trap vessel 266 and recycled into the wash line as shown in block 268. The recycled water is used directly from the trap vessel to wash the object in the sink. After the filter bag is cleaned, the filter bucket is reassembled and reinserted into the liquid path as shown in block 270. As shown in block 272 the cleaning liquid level should be checked and cleaning liquid added. Preferably, the entire cleaning system would be flushed and primed with all new cleaning liquid.

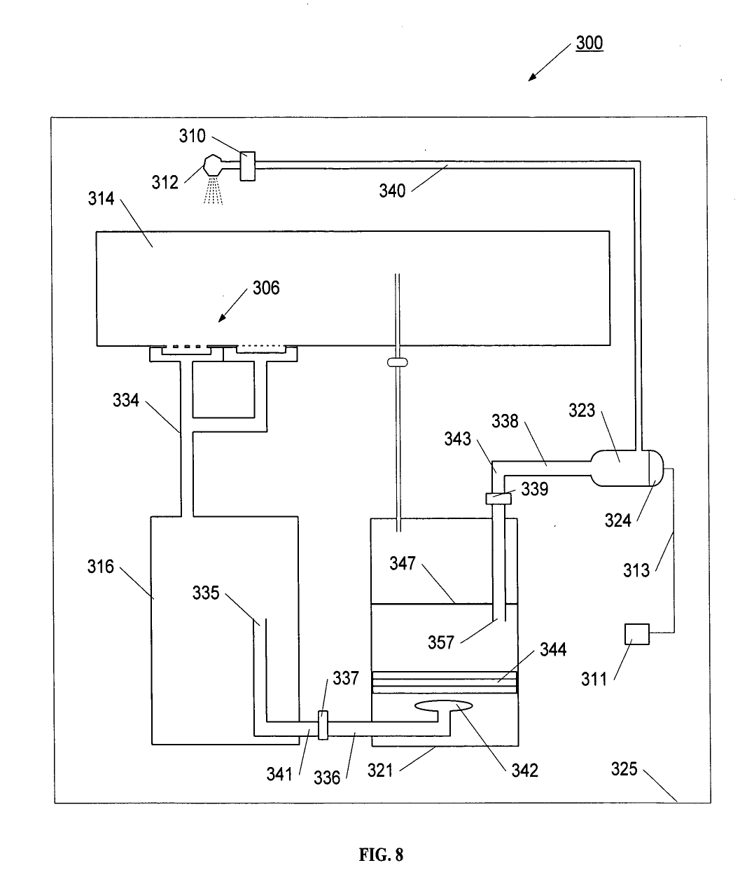

Referring now to FIG. 8, another washing system 300 is illustrated. Washing system 300 has a sink 314 for receiving a cleaning fluid distributed from washer 312. The sink 314 may include a screening system 306 for retaining larger chunks and pieces in sink 314. As described earlier, multiple screen sizes may be used. Matter that pass the screen, particulate matter, and cleaning fluid is drained from the sink 314 through drain line 334 into trap vessel 316. Heavier matter collects at the bottom of trap vessel 316, and therefore must be routinely cleaned to empty the collected contaminants. The water or cleaning liquid flows into feed inlet 335 and through feed line 336 to filter vessel 321. Preferably, the feed line 336 couples to a manifold 342 for more evenly distributing the liquid into the filter bucket 321. In one arrangement, the water or cleaning fluid flows by gravity from the sink 314 into the trap vessel 316 and into the filter vessel 321. It will be appreciated that other flow arrangements may be used. The cleaning liquid or water flows from the manifold 342 through filters 344. Filters 344 may be a single filter, or may be arranged as a layer of filters. For example, a first coarser filter may be positioned closer to manifold 342 while finer filters are positioned in the layer extending towards the top of the filter bucket 321. It will be understood that the filters may be made out of materials selected according to application specific needs.

Water or cleaning liquid that passes through the filter system 344 is presented to draw inlet 357. Draw inlet 357 is positioned to be below liquid level 347, but above the filters 344. In this way, relatively cleaner and filtered water or cleaning liquid is drawn from draw inlet 357 into draw line 338 and into pump 323. The cleaning liquid or water then is pumped by the pump 323 into wash line 340 for recycling through washer 312. The flow of water or cleaning solution may be controlled by a valve 310 positioned in the wash line 340. In one application, the pump 323 has pump control circuitry 324 which acts responsive to a sensor 311. The sensor 311 may be a simple foot switch or other switch controlled by the operator for activating and deactivating the pump. The sensor 311 may be coupled to the pump control circuitry 324 through a pump control line 313. In another example, the valve 310 is not necessary as the on/off function of sensor 311 controls the flow of water.

The washing system 300 may also contain a housing 325 for holding the cleaning system. In one example, the washing system includes a housing structure such as a cart of other portable housing to enable the cleaning system to be moved close to where the cleaning activity is needed.

Quick connects 337 and 339 enable the filter vessel to be easily removed from the cleaning system. The quick connects 337 and 339 are constructed to enable feed line portion 341 to be easily connected to draw line portion 343. When feed line portion 341 is coupled to draw line portion 343, the pump 323 may draw water directly from the trap vessel 316. In this way, washing may continue even when the filter bucket has been removed for cleaning. As described earlier, one particularly useful aspect of this configuration is the washing system may be used to clean its own filter.

While particular preferred and alternative embodiments of the present intention have been disclosed, it will be appreciated that many various modifications and extensions of the above described technology may be implemented using the teaching of this invention. All such modifications and extensions are intended to be included within the true spirit and scope of the appended claims.

1. A washing system using recycled cleaning liquid, comprising:
a washer fixture directed into a washing basin;
a trap vessel connected to the wash basin with a drain line;
a filter vessel connected to the trap vessel with a feed line;
a pump connected to the filter vessel with a draw line, and connected to a wash line; and
wherein the wash line is connected to the washer fixture.

2. The washing system according to claim 1 wherein the washing basin is a sink and the washer fixture is a faucet or a spray nozzle.

3. The washing system according to claim 1, further comprising:
a valve on the wash line;
a sensor arranged to generate a pump control signal responsive to the position of the valve;
pump control circuit coupled to the control signal; and
whereby when the valve is positioned to permit the cleaning liquid to flow from the washer fixture into the washing basin, the sensor generates the pump control signal to activate the pump.

4. The washing system according to claim 1, wherein the filter vessel is positioned sufficiently below the washing basin to enable the cleaning liquid to flow by the force of gravity from the washing basin into the filter vessel.

5. The washing system according to claim 1, wherein the filter vessel is positioned so that the pump moves the cleaning liquid from the trap vessel into the filter vessel.

6. The washing system according to claim 1, further comprising a bag filter in the filter vessel.

7. The washing system according to claim 1, further comprising a filter layer in the filter vessel.

8. The washing system according to claim 1, further comprising:
a float in the filter vessel;
an inlet supported by the float and coupled to the draw line;
wherein the float raises and lowers responsive to a level of the cleaning liquid to maintain the inlet in the cleaning liquid.

9. The washing system according to claim 1, further comprising a cart for holding the washer basin, the washer fixture, the trap vessel, the filter vessel, and the pump.

10. The washing system according to claim 9, further comprising:
wheels connected to the trap vessel or the filter vessel;
release mechanism for releasing the trap vessel or the filter vessel from the cart; and
whereby when released, the trap vessel or the filter vessel may be rolled away from the cart.

11. The washing system according to claim 1, further comprising a permanent housing for holding the washer basin, the washer fixture, the trap vessel, the filter vessel, and the pump.

12. The washing system according to claim 1, further comprising:
a filter vessel by-pass;
wherein the by-pass assembly enables the draw line to draw cleaning liquid directly from the trap vessel to the pump.

13. The washing system according to claim 12, wherein the by-pass assembly includes:
a feed line disconnect having a connector part;
a draw line disconnect having a mating connector part;
wherein the connector part and the mating connector part are couplable to bypass the filter vessel and to couple the feed line to the draw line.

14. A method of cleaning, comprising:
positioning a spray head near a part, the spray head directed to deliver a cleaning solution into a sink;
spraying, using the spray head, a stream of the cleaning liquid over the part, the cleaning liquid knocking away some chunks of the contaminant and dissolving some of the contaminant;
draining the cleaning liquid and chunks into a trap vessel, the trap vessel collecting larger of the chunks;
feeding the cleaning liquid from the trap vessel into a filter vessel;
filtering, in the filter vessel, smaller chunks and particulate contaminant from the cleaning liquid; and
pumping the filtered cleaning liquid to the spray head.

15. The method of cleaning according to claim 14, further including the following preparatory steps:
adding fresh cleaning solution to the trap vessel and the filter vessel; and
disconnecting from the source of the fresh cleaning solution so that no fresh cleaning solution is introduced during the spraying, draining, feeding, filtering, and pumping steps.

16. The method of cleaning according to claim 14, further comprising:
bypassing the filter vessel;
removing a filter from the filter vessel and using the filter as the part to be cleaned; and
pumping cleaning fluid from the trap vessel to the spray head without having the cleaning fluid pass through the filter vessel;

17. A portable washing system using recycled cleaning liquid, comprising:
a spray nozzle connected to a wash pipe and directed into a sink;
a trap bucket connected to the sink with a drain pipe;
a filter bucket connected to the trap bucket with a feed pipe;
a pump connected to the filter bucket with a draw pipe, and connected to a wash pipe; and
a cart supporting the spray nozzle, sink, trap bucket, filter bucket, and pump.

18. The portable washing system according to claim 17, wherein the filter bucket further includes:
a filter in the filter bucket;
a float buoyed by a cleaning liquid that has passed through the filter;
an inlet on the float that is connected to the draw pipe; and
wherein the float raises and lowers responsive to a level of the cleaning liquid to maintain the inlet in the cleaning liquid.

19. The portable washing system according to claim 18, further including more than one filter in the filter bucket.

20. The washing system according to claim 17 further including:
a sensor;
pump control circuitry;
a signal line connecting the sensor to the pump control circuitry; and
wherein the pump circuitry is arranged to active the pump when the sensor generates a control signal on the signal line.

21. A permanent washing system using recycled cleaning liquid, comprising:
a spray nozzle connected to a wash pipe and directed into a sink;
a trap bucket connected to the sink with a drain pipe;
a filter bucket connected to the trap bucket with a feed pipe;
a pump connected to the filter bucket with a draw pipe, and connected to a wash pipe; and
a permanent housing supporting the spray nozzle, sink, trap bucket, filter bucket, and pump.
